(19) United States
(12) Patent Application Publication
(10) Pub. No.: US 2010/0252530 A1
(43) Pub. Date: Oct. 7, 2010

(54) ETCHANT COMPOSITION AND METHOD

(75) Inventors: Robert Jeffrey Durante, Landenberg, PA (US); Seung Jin Lee, Yongin (KR); Thomas Peter Tufano, Wilmington, DE (US); Young Chul Park, Iksan-City (KR); Jun Woo Lee, Jeonju-City (KR); Seung Yong Lee, Daejeon (KR); Hyun Kyu Lee, Iksan City (KR); Yu Jin Lee, Iksan City (KR); Sang Hoon Jang, Jeonju-City (KR)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignees: E. I. DU PONT DE NEMOURS AND COMPANY, Wilmington, DE (US); DONGWOOD FINE-CHEM CO LTD, Seoul (KR)

(21) Appl. No.: 12/721,903

(22) Filed: Mar. 11, 2010

Related U.S. Application Data
(60) Provisional application No. 61/166,267, filed on Apr. 3, 2009.

(51) Int. Cl. C23F 1/02; B44C 1/22; C03C 15/00; C09K 13/00

(52) U.S. Cl. 216/41; 216/95; 252/79.1

(57) ABSTRACT

The present invention provides an etchant composition comprising
A) high strength potassium monopersulfate providing from about 0.025% to about 0.8% by weight of active oxygen;
B) from about 0.01% to about 30% by weight of the composition of B1) an organic acid, alkali metal salt of an organic acid, ammonium salt of an organic acid, or a homopolymer of an organic acid, or B2) a halogen or nitrate salt of phosphonium, tetrazolium, or benzolium, or B3) a mixture of component B1) and B2); and
C) from about 0% to about 97.49% by weight of the composition of water; and a method of etching a substrate using said composition.

### CROSS-REFERENCE TO RELATED APPLICATIONS

This application claims the benefit of U.S. Provisional Application No. 61/166,267 filed Apr. 3, 2009.

### FIELD OF THE INVENTION

The present invention relates to a wet etchant composition for use in the manufacture of electronic components, such as printed circuit boards, display panels, or semiconductors, and a method of etching or forming a metal pattern by using the same.

### BACKGROUND OF THE INVENTION

In general, in semiconductor devices and flat display devices, a process of forming a metal wire on a substrate consists of a metal film forming process by using sputtering, a photoresist forming process in a selective region by using photoresist application, exposure and development, and an etching process, and includes washing processes before and after individual unit processes.

The etching process is a process in which a metal film remains in a selective region by using a photoresist mask, and generally dry etching using plasma or wet etching using an etchant composition to remove excess debris and metal.

In order to form a copper-containing film and a copper alloy-containing film as a wire by using a wet etching process, various types of etchant compositions have been suggested, but have various disadvantages. During the etching process the metal concentration of the etchant solution increases. Thus it is desirable for the etchant composition to have a high metal loading capacity. However, in some prior art solutions, the dissolved metal acts as a catalyst in the etching process, negatively affecting the quality of the etching.

U.S. Pat. No. 7,442,323 discloses a high strength potassium monopersulfate for use in etching solutions, and a method of etching metals using such a compound. However, specific etching compositions are not disclosed.

Therefore, in order to avoid the etchant stability problems in this field, there is a need to develop an etchant composition that is not catalyzed by the dissolved metal taken up during the wet etching process, avoids salt precipitation, and which has excellent properties with respect to the etching. The present invention provides such an etching solution and method of etching using the same.

### BRIEF SUMMARY OF THE INVENTION

The present invention comprises an etchant composition comprising

A) high strength potassium monopersulfate providing from about 0.025% to about 0.8% by weight of active oxygen;

B) from about 0.01% to about 30% by weight of the composition of B1) an organic acid, alkali metal salt of an organic acid, ammonium salt of an organic acid, or a homopolymer of an organic acid, or B2) a halogen or nitrate salt of phosphomium, tetrazolium, or benzolium, or B3) a mixture of component B1) and B2); and

C) from about 0% to about 97.49% by weight of the composition of water.

The present invention further comprises a method of etching a substrate comprising 1) providing a substrate having a first metal film formed on a surface of the substrate, a second metal film formed on the first metal film, and an optional additional metal film formed on the second metal film, and 2) contacting said substrate with an etchant composition of the present invention as described above.

### BRIEF DESCRIPTION OF THE DRAWINGS

FIG. 1A is a scanning electron microscope (SEM) picture of a substrate on which a Cu/Mo double film and a photoresist were deposited, and which was then etched by using the etchant composition of Example 2.

FIG. 1B is a scanning electron microscope (SEM) picture of the substrate of FIG. 1A on which the Cu/Mo double film and photoresist were deposited and which was etched by using the etchant composition of Example 2, after the photoresist was stripped.

FIG. 2A is a scanning electron microscope (SEM) picture of a substrate on which a Cu/Mo double film and photoresist were deposited and which was etched by using the etchant composition of Example 3.

FIG. 2B is a scanning electron microscope (SEM) picture of the substrate of FIG. 2A on which the Cu/Mo double film and photoresist were deposited and which was etched by using the etchant composition of Example 3, after the photoresist was stripped.

### DETAILED DESCRIPTION OF THE INVENTION

Trademarks are shown herein by capitalization.

The term “high strength potassium monopersulfate” as used herein means an aqueous solution of potassium hydrogen peroxymonosulfate having an active oxygen content of 0.025%% to 0.8% by weight of active oxygen. The solution is commercially available in a concentrated form from E. I. du Pont de Nemours and Company, Wilmington, Del., and can be diluted for use. The solution can be prepared from the triple salt (2 KHSO₅.KHSO₄.K₂SO₄) available commercially as OXONE monopersulfate compound from E. I. du Pont de Nemours and Company, Wilmington Del., according to the process disclosed in U.S. Pat. No. 7,442,323.

The term “active oxygen” (AO) is the quantity of atomic oxygen in excess of that present in the corresponding reduced form of a compound. Active oxygen is expressed as a weight percent. For example, for KHSO₅, which has a reduced form of KHSO₄, the active oxygen is calculated by the following equation:

$$\% AO = \frac{weight in grams of ( O ) \times 100}{weight in grams of {KHSO}_{5}} = \frac{16 \times 100}{152} = 10.5$$

The present invention comprises an etchant composition that can etch a first metal film and a second metal film and collectively wet-etch a multi-film comprising the first single metal film, the second single metal film, and optional additional metal film. Preferably the first metal film on the surface of the substrate comprises molybdenum or titanium, and the second metal film comprises copper. The etchant composition has excellent etching properties and stability. The present invention further comprises a method of etching by using the etchant composition of the present invention. In addition, in the etching process, stability of the etchant formulation is ensured, there is no damage to a lower adhesion promoting film, and a uniform etching property is obtained. The composition can be applied to a large-sized substrate, and excellent productivity is provided because there is no damage to the apparatus employed.

The present invention provides an etchant composition which comprises A) high strength potassium monopersulfate in an amount to provide from about 0.025% to about 0.8% by weight of active oxygen, preferably from about 0.03% to about 0.6%, more preferably from about 0.03% to about 0.5%, by weight of active oxygen; B) from about 0.01% to about 30%, preferably from about 0.1% to about 20%, more preferably from about 0.1% to about 10% by weight of the composition of B1) an organic acid, acetate salt of organic acid, ammonium salt of organic acid; or a homopolymer of an organic acid, or B2) a halogen or nitrate salt of phosphomium, tetrazolium, or benzolium, or B3) a mixture of component B1) and B2); and C) from about 0% to about 97.49% by weight of the composition of water. Optional components of the etching composition include secondary oxidizers and anisotropic etching agents. Examples of suitable secondary oxidizers include ferric salts and hydrates thereof, cupric salts and hydrates thereof, hydrogen peroxide, or nitric acid. Anisotropic etching agents include aromatic or heterocyclic amine compounds.

The high strength potassium monopersulfate as used herein is an aqueous solution that has an active oxygen content of from about 0.025% to about 0.8% by weight of active oxygen. Commercially available solutions of high strength potassium monopersulfate will need to be diluted with water to obtain this active oxygen range suitable for use in etching. Use of the more concentrated commercial solution is likely to result in an etching time that is so short as to be impractical in manufacturing operations.

The high strength potassium monopersulfate that is included in the etchant composition according to the present invention is a component that oxidizes copper and improves the etching uniformity. In addition to high active oxygen, the high strength potassium monopersulfate solution also has a low concentration of inert sulfate salts. The active oxygen to inert salt weight ratio of the high strength potassium monopersulfate ranges from about 0.8:1 to about 1.7:1. The improved SO₅/SO₄ weight ratio greatly improves metal salt solubilities and eliminates precipitation problems found in the prior art. Dilution does not affect the ratio of active oxygen to inert sulfate salts. Thus dilution can be used to adjust the active oxygen to the desired range while still maintaining the ratio of active oxygen to inert sulfate salts. The active oxygen to inert sulfate salt weight ratio of prior art solid potassium monopersulfate triple salt, and solutions prepared from commercially available potassium monopersulfate salt in the prior art, is approximately 0.15:1.

High strength potassium monopersulfate is included in the etchant composition of the present invention in an amount of from about 2.5% to about 80% by weight based on the total weight of the composition. Preferably commercially available high strength potassium monopersulfate from E. I. du Pont de Nemours and Company, Wilmington, Del., is employed. High strength potassium monopersulfate is preferably included in an amount of from about 2.5% to about 80%, more preferably from about 3% to about 50%, more preferably from about 5% to about 50% by weight based on the total weight of the composition. A sufficient amount of the high strength potassium monopersulfate is used to avoid a reduced etching rate for copper, or any formation of stains due to the nonuniform etching. Use of an excessive amount of high strength potassium monopersulfate is avoided to prevent overetching of copper.

A second component of the etchant composition of the present invention is an organic acid, salt of an organic acid, or homopolymer of organic acid. Suitable organic acids are a water soluble carboxylic, dicarboxylic, or tricarboxylic acid. Preferably the acid is one or more of acetic acid, butanoic acid, citric acid, formic acid, gluconic acid, glycolic acid, malonic acid, oxalic acid, pentanoic acid, sulfobenzoic acid, sulfosuccinic acid, sulfophthalic acid, salicylic acid, sulfosalicylic acid, benzoic acid, lactic acid, glyceric acid, succinic acid, malic acid, tartaric acid, isocitric acid, propenoic acid, and alkali metal salt of each of the foregoing acids. Examples of salts of an organic acid suitable for use herein are a water soluble ammonium or alkali metal salt of a carboxylic acid, dicarboxylic acid, or tricarboxylic acid. Preferably the salt is one or more of an acetate, butanoate, citrate, formate, gluconate, glycolate, malonate, oxalate, pentanoate, sulfobenzoate, sulfosuccinate, sulfophthalate, or other similar salt. The salt can be an ammonium salt, sodium salt, potassium salt, or other alkali metal salt. Examples of suitable homopolymers of organic acid include polyacrylic acid, polyvinyl acid sulfate, and polyvinyl pyrrolidines.

As an alternative to the organic acid, salt thereof, or homopolymer thereof, a halogen or nitrate salt of phosphonium, tetrazolium, benzolium, or their substituted analogs, is suitable for use as the second component of the etchant composition. Preferred halogen salts are fluoride, chloride, bromide, or iodide. Also a mixture of the above-described organic acid, salt thereof, or a homopolymer thereof, and the phosphonium, tetrazolium, or benzolium salt is suitable for use as the second component of the etchant composition. Preferred substituents for the phosphonium, tetrazolium, or benzolium salts are C₁₀ to C₁₈ alkyl, benzyl, and C₁₀ to C₁₄ alkyl benzyl substitutes. Examples include tetraphenylphosphonium and triphenyltetrazolium.

The organic acid component is included in the etchant composition according to the present invention and functions to smoothly etch copper. It improves the etching amount, the etching rate, and the etching uniformity. The organic acid, salt thereof, homopolymer thereof, or the phosphonium, tetrazolium, or benzolium salt, or mixture thereof, is included in an amount of from about 0.01% to about 30% by weight based on the total weight of the etchant composition. This second component is preferably included in an amount of from about 0.01% to about 20%, more preferably from about 0.02% to about 10%, more preferably from about 0.02% to about 0.5% by weight based on the total weight of the composition. Use of excessive amounts of this component is avoided to prevent the overetching of copper.

The third component of the etchant composition of the present invention is water. The water that is used in the present invention is deionized water and usually, deionized water for semiconductor processes is used. It is preferable that the water used has a purity of 18 megaohms per centimeter or more. The water is the remainder of the etchant composition so that the total of the three components is 100% by weight of the etchant composition. Typically the water is present at from about 0% to about 97.49% by weight of the etchant composition, preferably from about 20% to about 95% by weight, and more preferably from about 30% to about 90% by weight of the etchant composition.

One optional component of the etchant composition is secondary oxidizers. Examples of suitable secondary oxidizers include ferric salts or hydrates thereof, cupric salts or hydrates thereof, hydrogen peroxide, or nitric acid. The ferric salts include those containing Fe³⁺ and the type of salt is not limited. Examples of suitable salts include one or more of Fe(NO₃)₃, Fe₂(SO₄)₃, NH₄Fe(SO₄)₂, FePO₄, or hydrates of each of the forgoing. The cupric salts are those containing Cu²⁺ and the type of salt is not limited. Examples of suitable salts include one or more of Cu(NO₃)₂, CuSO₄, NH₄CuPO₄, or hydrates of each of the forgoing. The secondary oxidizer included in the etchant composition according to the present invention, oxidizes molybdenum, increases the etching rate, removes the etched residual, and acts as an auxiliary oxidizing agent capable of etching copper.

The optional secondary oxidizer is included in an amount of from about 0.01% to about 15% by weight based on the total weight of the composition. The secondary oxidizer is preferably included in an amount of from about 0.1% to 10%, more preferably from about 0.5% to about 5% by weight based on the total weight of the composition. Use of excessive amounts of the secondary oxidizer is avoided to prevent damage of the underlying substrate or lower film, and to prevent increasing the etching rate significantly, and therefore possibly removing the pattern due to overetching. Examples of substrates are a semiconductor film such as glass and silicon oxide film, a silicon nitride film, an amorphous silicon, polysilicon, doped amorphous silicon, doped polysilicon and the like.

An additional optional component of the etchant composition of the present invention is an anisotropic etching agent. Suitable examples of such an agent are aromatic amine compounds. The optional amine compound that is included in the etchant composition according to the present invention is a component that contributes to control of the etching rate of the copper film. In addition, for heterocyclic aromatic amines, an unshared electron pair of a nitrogen atom that is provided in a hetero ring of the compound is bonded to copper to prevent organic contaminant substances from being readsorbed onto the copper, thus minimizing the attack of copper.

The aromatic amine compound is included in an amount of from about 0.005%, to about 10% by weight based on the total weight of the composition. The amine compound is preferably included in an amount of from about 0.01% to about 5%, more preferably from about 0.05% to about 3% by weight based on the total weight of the composition. The amine compound is one or more of pyrrolidine, pyrrolyn, pyrrole, indole, pyrazole, imidazole, pyrimidine, purine, pyridine, aminotetrazole, or a derivative thereof.

An additional optional component of the etchant composition of the present invention is a corrosion inhibitor. Suitable examples of corrosion inhibitors include organic acids, alkali metal salts thereof, and imidazoles. Examples of suitable inhibitors include the following acids: phthalic, citric, glycolic, benzoic, and sulfophthalic. Preferred salts include sodium or potassium. The corrosion inhibitor can be anodic, cathodic or a mixture thereof. Those that are anodic, or are mixtures with sufficient anodic character can also function as anisotropic etching agents.

The etchant composition according to the present invention can optionally further comprise phosphoric acid to provide a more uniform etch. The etchant composition according to the present invention can also further comprise one or more of a surfactant, a metal ion blocking agent, a corrosion preventing agent, and a pH controlling agent in addition to the above mentioned components. The corrosion preventing agent can include benzoic acid, its sulfonated derivative, or a phosphate such as disodium hydrogen orthophosphate.

The etching composition of the present invention is prepared by mixing of the components at ambient temperature. The components are blended in a manner that the total adds up to 100% by weight. The components can be blended in any sequence. A mechanical stirrer can be used to assure complete dissolution.

The present invention further comprises a method of etching a substrate comprising 1) providing a substrate having a first metal film formed on a surface of the substrate, a second metal film formed on the first metal film, and an optional additional metal film formed on the second metal film, and 2) contacting said substrate with an etchant composition as previously described above. Preferably the etchant composition comprises

A) high strength potassium monopersulfate providing from about 0.025% to about 0.8% by weight of active oxygen;

B) from about 0.01% to about 30% by weight of the composition of B1) an organic acid, alkali metal salt of an organic acid, ammonium salt of an organic acid, or a homopolymer of an organic acid, or B2) a halogen or nitrate salt of phosphonium, tetrazolium, or benzolium, or B3) a mixture of component B1) and B2); and

C) from about 0% to about 97.49% by weight of the composition of water.

Preferably the first metal film on the surface of the substrate comprises molybdenum or titanium, and the second metal film comprises copper.

In the method of the present invention the initial step 1) includes providing a substrate which has on a surface of the substrate one or a plurality of a first metal film, and a second metal film on the first metal film. Suitable substrates include a silicon wafer, a glass substrate, a stainless steel substrate, a plastic substrate or a quartz substrate. The substrate can be obtained with the metal films already present on the substrate surface, or the metal films can be formed on the surface. The substrate can be previously patterned using a photomask process, or unpatterned. The metal films can be formed by any of a variety of methods. It is preferable that a vacuum deposition method or a sputtering method be used to form the films. The films can then be subjected to a typical washing process, followed by a conventional photomask process.

In the second step 2) the substrate, which may have been previously patterned, is etched by contacting the substrate with the etchant composition of the present invention. The contacting can include a dipping method, a spray method, and other means of contacting. During the etching process, the temperature of the etching solution is in the range of from about 25° C. to about 50° C. The temperature can be changed in consideration of other processes and other factors, if necessary.

Alternatively, a pattern is formed on the substrate using a photoresist process prior to contacting with the etchant solution of the present invention as described above. The photoresist is formed on the outermost film deposited in step 1) by first layering a photoresist mask onto the second film. The photoresist is selectively exposed by lithography, typically by exposure to light. The light reacts with a photo-initiator to cause a change in the exposed portion of the film. The exposed photoresist is subjected to post baking. The post baked photoresist is developed by contacting with a conventional developing solution to form a photoresist or masking pattern. The first and second films, on which the photoresist pattern was formed, are then etched by contacting with the etchant composition according to the present invention as previously described to accomplish a metal pattern.

When an anisotropic etching agent is present in the etchant composition as a corrosion inhibitor, the etching rate is modulated or decreased in two ways. First the anisotropic etching agent reduces the overall copper etch rate and allows the etchant to take advantage of the existing hydrodynamic condition. Generally the overall copper etch rate would be too fast causing photoresist pattern attachment to the substrate to be lost as copper removal completely undercuts the pattern. This is due to large excess of oxidizer in the formulation needed to provide enough etching capacity for certain applications, such as liquid crystal display panels. However, there is a hydrodynamic condition where the force of the sprayed etchant is greater at bottom of the thin film transitor pattern than at the sides underneath the photo resist. As copper is etched away the overhanging photoresist shields the underlying copper. The anisotropic etching agent moderates (decreases) the etching rate in the second way by decreasing the rate to a greater extent where the solution velocity is slower under the photoresist pattern. Corrosion inhibitors that can provide adsorption to the anodic surface will be susceptible to mass transport controlled reaction rates. Higher solution velocities reduce the mass transport condition and allow faster downward etching than sideways etching.

In the method of the present invention, the first metal film, and the second metal film can be any one or a plurality of a data line, a scan line, a gate electrode, and a source/drain electrode of a flat display device.

The method of the present invention is useful in the manufacture of electronic components, such as printed circuit boards, display panels, or semiconductors. The method is useful for small or large sized substrates. Uniform etching is obtained without damage to the lower adhesion promoting film.

### Test Methods

Test Method 1—Electrochemical Test Method

An electrochemical method was used to evaluate the anodic character of the inhibitor and the inhibitor's response to solution velocity of the etchant composition. The instrumentation used was a Gamry MultEchem 8, running EIS 300, and DC 105 software. The potentiostat system was a three electrode system with copper working electrode, platinum counter electrode, and a SCE with Luggin type salt bridge. The rotated electrode was a Pine model AGMSRCE. Anodic character of a sample etchant composition was measured using a DC polarization curve and etch rates were measured using AC Electrochemical Impedance Spectroscopy (EIS). Measurements were made with both a static electrode and a rotating disk electrode.

### EXAMPLES

### Examples 1 to 3

Test coupons were prepared by first depositing a film of molybdenum of 100 to 500 angstroms in thickness using direct current sputtering onto a glass substrate surface from Corning Incorporated, Corning, N.Y. This was followed by forming a copper film of 1000 to 5000 angstroms in thickness on the molybdenum film using direct current sputtering. The coupon was then patterned by a photomask process. A positive photoresist (DWD-520 available from Dongwoo Fine-Chem Company Ltd., Seoul, S. Korea) was spin coated onto the copper film to form a mask. The coupon was then subjected to light passing through a lithograph, and photo-initiators in the resist polymerized the exposed portion of the photoresist. This was followed by developing by contacting with a solution of 2.4% by weight of tetramethyl ammonium hydroxide to remove the unexposed unpolymerized portion of the photoresist, thereby leaving a pattern on the coupon.

Etchant compositions were prepared by mixing the components according to the weight percents described in the following Table 1. The etchant compositions of Examples 1 to 3 and the test coupons were inserted into a spray type etching test apparatus (manufactured by SEMES, Co., Ltd.), and heated to 30° C. When the temperature approached 30° C.±0.1° C., the etchant composition to be tested was sprayed onto a test coupon. The spraying was continued for the number of seconds listed in Table 2 under EPD (End Point Detection) plus 40% more time. After this time the substrate was removed from the apparatus. The substrate was then washed by using deionized water and dried by using a hot forced-air drying device. The photoresist was removed by using a photoresist stripper. After washing and drying, a scanning electron microscope (SEM; manufactured by HITACHI, Co., Ltd., trademark: S-4700) was used to evaluate the side etching loss, any damage to the lower film, and etching residual substances. The resulting data is shown in Table 2.

### Comparative Examples A and B

Etchant solutions were prepared by mixing the components according to the weight percents described in the following Table 1. The process of Examples 1 to 3 was employed to etch test coupons. The resulting etched coupons were evaluated using a scanning electron microscope as in. Examples 1 to 3. The resulting data is shown in Table 2.

TABLE 1

| | | | | | | Etching | | |
|---|---|---|---|---|---|---|---|---|
| | HSPM* | Organic | | | | agent,*** | | Water |
| | (% by | acid** (% | | Secondary Oxidizer (% by | | amine (% by | | (% by |
| Example | weight) | by weight) | | weight) | | weight) | | weight) |
| 1 | 10 | C₂H₄O₃ | 5 | (NH₄)₂Fe(SO₄)•6H₂O | 4 | CH₃N₅ | 0.5 | 80.5 |
| 2 | 15 | C₂H₄O₃ | 5 | (NH₄)₂Fe(SO₄)•6H₂O | 5 | CH₃N₅ | 0.5 | 74.5 |
| 3 | 20 | C₂H₄O₃ | 7 | (NH₄)₂Fe(SO₄)•6H₂O | 5 | CH₃N₅ | 1 | 67.0 |
| Comp. A | 2 | C₂H₄O₃ | 2 | (NH₄)₂Fe(SO₄)•6H₂O | 1 | CH₃N₅ | 4 | 91.0 |
| Comp. B | 30 | C₂H₄O₃ | 3 | (NH₄)₂Fe(SO₄)•6H₂O | 7 | CH₃N₅ | 0.5 | 59.5 |

*HSPM is high strength potassium monopersulfate obtained from E. I. du Pont de Nemours and Company, Wilmington, DE.
**C₂H₄O₃ = Glycolic acid
***CH₃N₅ = 5-Aminotetrazole

TABLE 2

| | Type | Etching property results | | | |
|---|---|---|---|---|---|
| | of thin | | S/E (micro- | Damage to | |
| Example | film | EPD (sec) | meters) | lower film | Residuals |
| 1 | Cu/Mo | 42 | 0.60 | None | None |
| 2 | | 35 | 0.58 | None | None |
| 3 | | 28 | 0.52 | None | None |

| Comp. A | Etching did not occur | | |
|---|---|---|---|
| Comp. B | Disappearance of pattern | None | None |

EPD = end point detection
S/E = Side etch

From Table 2, it can be seen that when the etching was performed using the etchant compositions of Examples 1 to 3 of the present invention, excellent etching properties were obtained. In the case of Comparative Example A, where the content of the high strength potassium monopersulfate in the etchant composition was lower than in that of Examples 1 to 3, and the content of heterocyclic amine compound was higher than that in Examples 1 to 3, there was a problem in that copper was not etched. In the case of Comparative Example B, where the content of high strength potassium monopersulfate and the secondary oxidizer in the etchant solution were higher than that used in Examples 1 to 3, the etching rate of the double film of copper and molybdenum was significantly increased and wire was lost due to over etching.

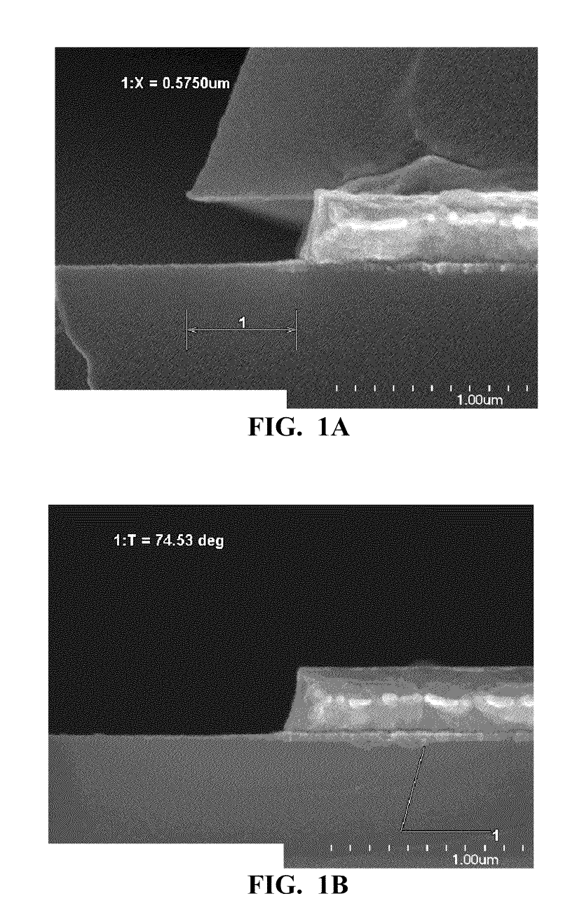

FIG. 1A is a SEM picture of a substrate on which a Cu/Mo double film and photoresist were deposited and which was etched by using an etchant composition of Example 2. FIG. 1B is a SEM picture of the substrate of FIG. 1A on which the Cu/Mo double film and photoresist were deposited and which was then etched by using the etchant composition of Example 2, after the photoresist was stripped.

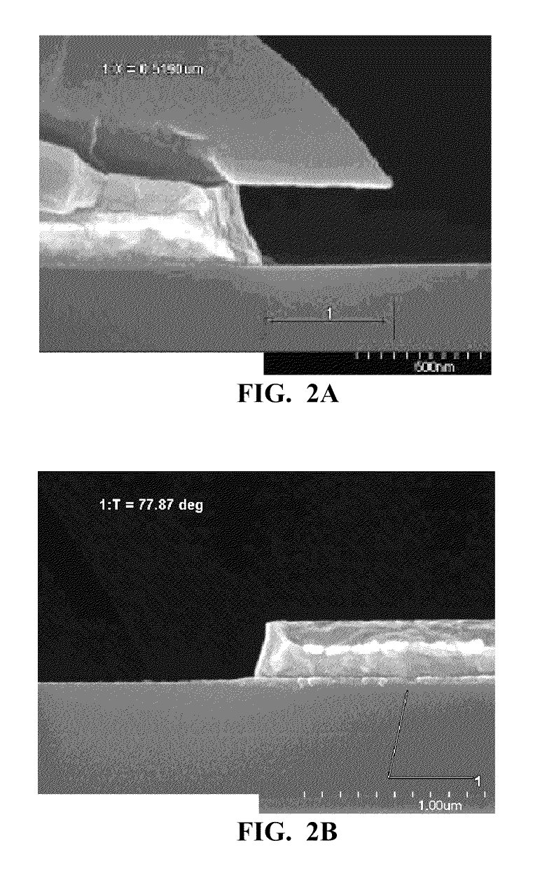

FIG. 2A is a SEM picture of a substrate on which a Cu/Mo double film and photoresist were deposited and which was etched by using an etchant composition of Example 3. FIG. 2B is a SEM picture of the substrate of FIG. 2A on which the Cu/Mo double film and photoresist were deposited and which was etched by using the etchant composition of Example 3, after the photoresist was stripped.

With reference to FIGS. 1A, 1B, 2A, and 2B, it can be seen that for Examples 2 and 3 a galvanic phenomenon (overetching of the molybdenum film) did not occur in the Cu/Mo double film. The profile of the pattern was excellent and the lower film was not damaged.

### Examples 4 to 7

Etchant solutions were prepared containing a secondary oxidizer by mixing the components according to the weight percents described in the following Table 3. The process of Examples 1 to 3 was employed to etch test coupons. The resulting etched coupons were evaluated using a scanning electron microscope as in Examples 1 to 3. The resulting data is shown in Table 3.

TABLE 3

| | HSPM^{a} | H₂O₂ | % | | % by weight | EPD^{b} | S/E^{c} | |
|---|---|---|---|---|---|---|---|---|
| | % by | % by | Active | Secondary | 2ndary | Cu/Mo | micro- | T/A^{d} |
| Example | weight | weight | oxygen | Oxidizer | oxidizer | (sec) | meters | degrees |
| Control 1 | 40 | 0 | 0.4 | None- | 0 | 25/UE^{e} | PO^{f} | PO |
| | | | | Control 1 | | | | |
| 4 | 40 | 0 | 0.4 | Fe(NO₃)₃ | 0.1 | 5/10 | PO | PO |
| 5 | 40 | 0 | 0.4 | Fe(NO₃)₃ | 0.3 | 1/5 | PO | PO |
| Control 2 | 40 | 1 | 0.6 | None- | 0 | 5/160 | PO | PO |
| | | | | Control 2 | | | | |
| 6 | 40 | 1 | 0.6 | Cu2+ | .25 | 5/60 | PO | PO |
| 7 | 40 | 1 | 0.6 | Cu2+ | 0.46 | 2/37 | PO | PO |

^{a}HSPM is high strength potassium monopersulfate obtained from E. I. du Pont de Nemours and Company, Wilmington, DE.
^{b}EPD is end point detection. The initial number is for the end point of etching of the copper, and the second number is for the end point of the molybdenum etching.
^{c}S/E is occurrence of side etching
^{d}T/A is Taper angle
^{e}UE indicates unetched
^{f}Each PO = patterning out, the photoresist pattern was lost or etched away.

The data in Table 3 demonstrates that the presence of a secondary oxidizer is needed to quickly etch the molybdenum metal film. For Control 1, containing no secondary oxidizer, the molybdenum layer remained unetched. For Control 2, containing no secondary oxidizer, etching of the molybdenum layer required 160 seconds. This example showed a change in the molybdenum etch rate with the presence of the secondary oxidizer.

The data in Table 3 also demonstrated that without an organic acid present in the etchant solution, patterning out resulted, in that the pattern was lost or etched away.

### Examples 8 to 9

Etchant solutions were prepared by mixing the components according to the weight percents described in the following Table 4. The process of Examples 1 to 3 was employed to etch test coupons. The resulting etched coupons were evaluated using a scanning electron microscope as in Examples 1 to 3. The resulting data is shown in Table 4.

TABLE 4

| | | | | | % by | | | |
|---|---|---|---|---|---|---|---|---|
| | | | | | weight | EPD^{b} | S/E^{c} | |
| | HSPM^{a} % | Na₂HPO₄ | % Active | | organic | Cu/Mo | micro- | T/A^{d} |
| Example | by weight | % by weight | oxygen | Organic acid | acid | (sec) | meters | degrees |
| Control | 40 | 0.5 | 0.4 | None- | 0 | 15/58 | 3.8 | 72.1 |
| | | | | Control | | | | |
| 8 | 40 | 0.5 | 0.4 | Acetic Acid | 0.1 | 15/40 | 1.8 | 78.1 |
| 9 | 40 | 0.5 | 0.4 | Acetic acid | 0.3 | 15/37 | 1.2 | 73 |

^{a}HSPM is high strength potassium monopersulfate obtained from E. I. du Pont de Nemours and Company, Wilmington, DE.
^{b}EPD is end point detection. The initial number is for the end point of etching of the copper, and the second number is for the end point of the molybdenum etching.
^{c}S/E is occurrence of side etching
^{d}T/A is Taper angle

The data in Table 4 demonstrates that with the presence of an organic acid, the molybdenum layer can be etched without loss of the pattern. Also Na₂HPO₄ acted as a corrosion inhibitor for the molybdenum. The side etching shown by Examples 8 and 9 is improved versus that of Examples 4 to 7 without the organic acid present. This is demonstrated by improved side etching results where side etching was minimized to avoid patterning out.

### Examples 10-16

Etchant solutions were prepared by mixing the components according to the weight percents described in the following Table 5. The process of Examples 1 to 3 was employed to etch test coupons. The resulting etched coupons were evaluated using a scanning electron microscope as in Examples 1 to 3. The resulting data is shown in Table 5.

TABLE 5

| | | | | | Organic | | | |
|---|---|---|---|---|---|---|---|---|
| | HSPM^{a} | Ammonium | | | acid % | EPD^{b} | S/E^{c} | |
| | % by | Acetate % | % Active | Organic | by | Cu/Mo | micro- | TA^{d} |
| Examples | weight | by weight | oxygen | acid | weight | (sec) | meters | degrees |
| Control | 40 | 4 | 0.4 | None | 0 | 19/23 | 1.3 | 49.3 |
| 10 | 40 | 4 | 0.4 | Sulfo- | 0.1 | 19/23 | 1.5 | 51.6 |
| | | | | benzoic | | | | |
| | | | | acid | | | | |
| 11 | 40 | 4 | 0.4 | Sulfo- | 1.0 | 19/23 | 1.4 | 68.2 |
| | | | | benzoic | | | | |
| | | | | acid | | | | |
| 12 | 40 | 4 | 0.4 | Sulfo- | 2.0 | 19/23 | 1.7 | 74.2 |
| | | | | benzoic | | | | |
| | | | | acid | | | | |
| 13 | 40 | 4 | 0.4 | Sulfo- | 0.5 | 31/37 | 1.9 | 55.1 |
| | | | | succinic | | | | |
| | | | | acid | | | | |
| 14 | 40 | 4 | 0.4 | Sulfo- | 1.0 | 31/39 | 2.0 | 71.8 |
| | | | | succinic | | | | |
| | | | | acid | | | | |
| 15 | 40 | 4 | .4 | Sulfo- | 0.5 | 37/42 | 1.8 | 56.4 |
| | | | | phthalic | | | | |
| | | | | acid | | | | |
| 16 | 40 | 4 | .4 | Sulfo- | 1.0 | 45/50 | 2.2 | 63.4 |
| | | | | phthalic | | | | |
| | | | | acid | | | | |

^{a}HSPM is high strength potassium monopersulfate obtained from E. I. du Pont de Nemours and Company, Wilmington, DE.
^{b}EPD is end point detection. The initial number is for the end point of etching of the copper, and the second number is for the end point of the molybdenum etching.
^{c}S/E is occurrence of side etching
^{d}T/A is Taper angle

The data in Table 5 shows that as the level of organic acid increased, the taper angle increased. One parameter of anisotropic etching is the taper angle. The taper angle is an indication how the etchant is removing metal in the vertical direction faster than the horizontal direction of the pattern. If etching were equal in both directions the angle would be 45 degrees. Table 5 shows that the taper angle can be adjusted to create better etching. Examples 10, 11 and 12 demonstrated increased taper angle with increasing acid concentration. Also Examples 13 and 14, and Examples 15 and 16, demonstrated an increased taper angle with increasing acid concentration.

### Examples 17-18

Etchant solutions were prepared by mixing the components according to the weight percents described in the following Table 6. The process of Examples 1 to 3 was employed to etch test coupons. The resulting etched coupons were evaluated using a scanning electron microscope as in Examples 1 to 3. The resulting data is shown in Table 6.

TABLE 6

| | HSPM^{a} | Ammonium | Na₂HP₄ | | Amine | EPD^{b} | S/E^{c} | |
|---|---|---|---|---|---|---|---|---|
| | % by | Acetate | % by | | % by | Cu/Mo | micro- | TA^{d} |
| Example | weight | % by weight | weight | Amine | weight | (sec) | meters | degrees |
| 17 | 40 | 3 | 0.5 | imidazole | 1 | 15/58 | 3.8 | 72.1 |
| 18 | 40 | 3 | 0.5 | imidazole | 2 | 15/31 | 1 | 66 |

^{a}HSPM is high strength potassium monopersulfate obtained from E. I. du Pont de Nemours and Company, Wilmington, DE.
^{b}EPD is end point detection. The initial number is for the end point of etching of the copper, and the second number is for the end point of the molybdenum etching.
^{c}S/E is occurrence of side etching
^{d}T/A is Taper angle

The data in Table 6 demonstrates use of an imidazole as the anisotropic etching agent was very effective in the etchant composition of the present invention to obtain excellent etching properties.

### Examples 19-20

Etchant solutions were prepared by mixing the components according to the weight percents described in the following Table 7. The process of Examples 1 to 3 was employed to etch test coupons. The resulting etched coupons were evaluated using a scanning electron microscope as in Examples 1 to 3. The resulting data is shown in Table 7.

TABLE 7

| Ex- | HSPM* | Ammonium | Na₂HPO₄ | | Amine | Mo |
|---|---|---|---|---|---|---|
| am- | % by | Acetate % | % by | | % by | Under- |
| ple | weight | by weight | weight | Amine | weight | cut |
| Con- | 40 | 3 | 0 | imidazole | 2 | yes |
| trol | | | | | | |
| 19 | 40 | 3 | 0.3 | imidazole | 2 | no |
| 20 | 40 | 3 | 0.5 | Imidazole | 2 | no |

*HSPM is high strength potassium monopersulfate obtained from E. I. du Pont de Nemours and Company, Wilmington, DE.

The data in Table 7 shows that disodium hydrogen orthophosphate was effective to protect molybdenum from being undercut during etching. If the etching is too aggressive the molybdenum may be undercut along the substrate material as shown by the Control. Examples 19 and 20 demonstrated that aggressive etching can be used without the undercutting if the disodium hydrogen orthophosphate is present in the etchant solution.

### Examples 21-25

Etchant solutions containing anisotropic etching agents were prepared by mixing the components in the weight percentages listed in the following Table 8. The solutions were evaluated for anodic character of the anisotropic etching agent, and the agent's response to solution viscosity according to Test Method 1. The resulting data is shown in Table 8.

TABLE 8

| | | | | | | | Polarization | | |
|---|---|---|---|---|---|---|---|---|---|
| | | | | Nitric | Ammonium | Rotated | resistance, | | |
| Example | | AEA | HSPM^{b} | Acid | Fluoride | Speed | Rp | ER^{c} | % |
| No. | AEA^{a} | concentration | (wt %) | (wt %) | (wt %) | (rpm) | (ohm/cm²) | A/sec | IE^{d} |
| | Control | 0 | 40 | 4 | 0.4% | static | 2.05 | 58.4 | n/a |
| 21 | TPPC^{e} | 500 | 40 | 4 | 0.4 | static | 64.28 | 1.0 | 97 |
| 22 | TPPC | 400 | 40 | 4 | 0.4 | 0 | 63.3 | 1.65 | |
| 23 | TPPC | 400 | 40 | 4 | 0.4 | 500 | 4.55 | 19.91 | |
| 24 | TPPC | 400 | 40 | 4 | 0.4 | 1000 | 4.84 | 18.92 | |
| 25 | TPPC | 400 | 40 | 4 | 0.4 | 2000 | 3.67 | 24.75 | |

^{a}AEA = anisotropic etching agent
^{b}HSPM is high strength potassium monopersulfate obtained from E. I. du Pont de Nemours and Company, Wilmington, DE
^{c}ER = Etch rate in angstroms per second
^{d}IE = inhibitor efficiency
^{e}TPPC = tetraphenylphosphonium chloride

Table 8 shows that tetraphenylphosphonium salts decreased the etch rate compared to the control and can be used to reduce the corrosion rate. For the control versus Example 21 the polarization resistance Rp was increased with the addition of the tetraphenylphosphonium salt, and thus the corresponding etch rate was decreased by 97% inhibitor efficiency. In Examples 22-25 using a rotated disk electrode the etch rate increased with increasing rpms or solution velocity showing that there was a mass transport influence. The anodic adsorption properties of the agent allowed rapid adsorption to slow the etch rate down but not stop etching.

### Examples 26-37

Etchant solutions containing optional copper corrosion inhibitor agents, optional secondary oxidizers, and an optional pH control agent, were prepared by mixing the components in the weight percentages listed in the following Table 9A. The solutions were evaluated for anodic character of the anisotropic etching agent, and the agent's response to solution viscosity according to Test Method 1. The resulting data is shown in Table 9B.

TABLE 9A

| | | Ammonium | CuSO₄ | 35% | | pH adjust | | |
|---|---|---|---|---|---|---|---|---|
| Example | HSPM^{a} | Acetate | 5H₂0 | H₂0₂ | | Acid | Solution | |
| No. | wt % | wt % | (wt %) | (wt %) | pH | Used | movement | Inhibitor |
| Control | 40 | 2 | 0.5 | 3 | 2.5 | H₂S0₄ | Static | Control |
| 26 | 40 | 2 | 0.5 | 3 | 2.5 | H₂S0₄ | Static | Phthalic acid |
| 27 | 40 | 2 | 0.5 | 3 | 2.5 | H₂S0₄ | Static | Citric acid |
| 28 | 40 | 2 | 0.5 | 3 | 2.5 | H₂S0₄ | Static | Sodium |
| | | | | | | | | benzoate |
| 29 | 40 | 2 | 0.5 | 3 | 2.5 | H₂S0₄ | Static | Citric acid |
| 30 | 40 | 2 | 0.5 | 3 | 2.5 | H₂S0₄ | Static | Phthalic acid |
| 31 | 40 | 2 | 0.5 | 3 | 2.5 | H₂S0₄ | Static | Sodium |
| | | | | | | | | benzoate |
| 32 | 40 | 2 | 0.5 | 3 | 2.5 | H₂S0₄ | Static | Glycolic acid |
| 33 | 40 | 2 | 0.5 | 3 | 2.5 | H₂S0₄ | Static | Sulfophthalic |
| | | | | | | | | acid |
| 34 | 40 | 2 | 0.5 | 3 | 2.5 | H₂S0₄ | Static | Imidazole |
| 35 | 40 | 2 | 0.5 | 3 | 2.5 | H₂S0₄ | Static | Glycolic acid |
| 36 | 40 | 2 | 0.5 | 3 | 2.5 | H₂S0₄ | Static | Imidazole |
| 37 | 40 | 2 | 0.5 | 3 | 2.5 | H₂S0₄ | Static | Sulfophthalic |
| | | | | | | | | acid |

^{a}HSPM is high strength potassium monopersulfate from E. I. du Pont de Nemours and Company, Wilmington, DE

TABLE 9B

| | visible anodic | Rp Cu | |
|---|---|---|---|
| Example | behavor | (ohm/cm²) | Cu Inhibitor Efficiency % |
| Control | n/a | 1.1325 | n/a |
| 26 | none | 9.9811 | 89 |
| 27 | small | 9.966 | 89 |
| 28 | none | 8.758 | 87 |
| 29 | none | 7.5047 | 85 |
| 20 | none | 4.9528 | 77 |
| 31 | none | 3.02 | 62 |
| 32 | none | 3.0049 | 62 |
| 33 | none | 2.3858 | 53 |
| 34 | none | 2.0687 | 45 |
| 35 | none | 1.9479 | 42 |
| 36 | none | 1.359 | 17 |
| 37 | none | 1.208 | 6 |

The data in Table 9 demonstrates that the polarization resistance Rp increased for all Examples compared to the control. This demonstrates that the inhibitors were functioning to inhibit corrosion. The fact that no visible anodic behavior was observed demonstrates that these compounds were not functioning as anisotropic etching agents.

### Examples 38-42

Etchant solutions containing anisotropic etching agents were prepared by mixing the components in the weight percentages listed in the following Table 10. The solutions were evaluated for anodic character of the anisotropic etching agent, and the agent's response to solution viscosity according to Test Method 1. The resulting data is shown in Table 10.

TABLE 10

| | | | | Nitric | Amm.^{c} | Rotated | | | |
|---|---|---|---|---|---|---|---|---|---|
| Example | AEA^{a} | AEA | HSPM^{b} | Acid | Fluoride | Speed | Rp^{d} | ER^{e} | |
| No. | used | conc. | (wt %) | (wt %) | (wt %) | (rpm) | (ohm/cm²) | A/sec | % IE^{f} |
| Control | Control | 0 | 40 | 4 | 0.4% | static | 2.05 | 58.4 | n/a |
| 38 | TPTC^{g} | 500 | 40 | 4 | 0.4 | static | 17.31 | 5.49 | 88 |
| 39 | TPTC | 500 | 40 | 4 | 0.4 | 0 | 15.06 | 7.71 | |
| 40 | TPTC | 500 | 40 | 4 | 0.4 | 500 | 3.55 | 25.76 | |
| 41 | TPTC | 500 | 40 | 4 | 0.4 | 1000 | 2.57 | 37.15 | |
| 42 | TPTC | 500 | 40 | 4 | 0.4 | 2000 | 2.57 | 37.18 | |

^{a}AEA = anisotropic etching agent
^{b}HSPM = high strength potassium monopersulfate obtained from E. I. du Pont de Nemours and Company, Wilmington, DE
^{c}Amm = ammonium
^{d}Rp = polarization resistance
^{e}ER = Etch rate in angstroms per second
^{f}IE = inhibitor efficiency
^{g}TPPC —triphenyl tetrazolium chloride

Table 10 shows that tetraphenylphosphonium chloride decreased the etch rate compared to the control and can be used to reduce the corrosion rate. The direct current polarization curve indicated the tetraphenylphosphonium salt was a mixed inhibitor that had adsorption properties. In Examples 40-42 using a rotated disk electrode the etch rate increased with increasing rpms or solution velocity showing that there was a mass transport influence. The anodic adsorption properties of the agent allowed rapid adsorption to slow the etch rate down but not stop etching.

### Examples 43-44

Etchant solutions containing anisotropic etching agents were prepared by mixing the components in the weight percentages listed in the following Table 11. The solutions were evaluated for anodic character of the anisotropic etching agent, and the agent's response to solution viscosity according to Test Method 1. The resulting data is shown in Table 11.

TABLE 11

| | | AEA | | Nitric | Amm.^{c} | Amm.^{c} | Sodium | | | | |
|---|---|---|---|---|---|---|---|---|---|---|---|
| | | conc. | | Acid | bi- | Acetate | Sulfate | Rotated | | | |
| | AEA^{a} | (wt | HSPM^{b} | (wt | flouride | (wt | (wt | Speed | Rp^{d} | ER^{e} | % |
| Example | used | %) | wt % | %) | (wt %) | %) | %) | (rpm) | (ohm/cm²) | (a/sec) | IE^{f} |
| Control | Control | 0 | 40 | 4.45 | 0.23% | 1.5 | | Static | 4.87 | 19.5 | n/a |
| 43 | PAA^{g} | 0 | 40 | 4.45 | 0.4 | 1.5 | 6 | Static | 6.67 | 14.3 | 27 |
| 44 | PAA | 0.2 | 40 | 4.45 | 0.4 | 1.5 | 6 | Static | 20.03 | 4.7 | 76 |

^{a}AEA = anisotropic etching agent
^{b}HSPM = high strength potassium monopersulfate obtained from E. I. du Pont de Nemours and Company, Wilmington, DE
^{c}Amm. = ammonium
^{d}Rp = polarization resistance
^{e}ER = Etch rate in angstroms per second
^{f}IE = inhibitor efficiency
^{g}PAA = polyacrylic acid

The data in Table 11 demonstrates that polyacrylic acid was effective as an anisotropic etching agent and corrosion inhibitor. The data also shows

that sulfate ions were capable of reducing copper etch rate.

What is claimed is:

1. An etchant composition comprising
A) high strength potassium monopersulfate providing from about 0.025% to about 0.8% by weight of active oxygen;
B) from about 0.01% to about 30% by weight of the composition of B1) an organic acid, alkali metal salt of an organic acid, ammonium salt of an organic acid, or a homopolymer of an organic acid, or B2) a halogen or nitrate salt of phosphomium, tetrazolium, or benzolium, or B3) a mixture of component B1) and B2); and
C) from about 0% to about 97.49% by weight of the composition of water.

2. The etchant composition of claim 1 wherein the high strength potassium monopersulfate is present at from about 2.5% to about 80% by weight of the composition.

3. The etchant composition of claim 1 wherein the organic acid is a water soluble carboxylic acid, water soluble di-carboxylic acid, or water soluble tri-carboxylic acid.

4. The etchant composition of claim 1, wherein the organic acid is selected from the group consisting of acetic acid, butanoic acid, citric acid, formic acid, gluconic acid, glycolic acid, malonic acid, oxalic acid, pentanoic acid, sulfobenzoic acid, sulfosuccinic acid, sulfophthalic acid, salicylic acid, sulfosalicylic acid, benzoic acid, lactic acid, glyceric acid, succinic acid, malic acid, tartaric acid, isocitric acid, and propenoic acid.

5. The etchant composition of claim 1 further comprising an optional secondary oxidizer selected from the group consisting of a ferric salt, a cupric salt, hydrogen peroxide, and nitric acid.

6. The etchant composition of claim 5 wherein the optional secondary oxidizer is a ferric salt compound containing Fe3+ selected from the group consisting of Fe(NO₃)₃, Fe₂(SO₄)₃, NH₄Fe(SO₄)₂, FePO₄, and hydrates of each of the forgoing, or is a cupric salt selected from the group consisting of Cu(NO₃)₂, CuSO₄, NH₄CuPO₄, and hydrates of each of the forgoing.

7. The etchant composition of claim 1 further comprising an anisotropic etching agent selected from the group consisting of pyrrolidine, pyrrolyn, pyrrole, indole, pyrazole, imidazole, pyrimidine, purine, pyridine, and aminotetrazole tetraphenylphosphonium salts, substituted phosphonium salts, triphenylazolium salts, substituted tetrazolium salts, and substituted benzolium salts.

8. The etchant composition of claim 1 further comprising a corrosion inhibitor which is an organic acid, alkali metal salt thereof, or an anisotropic etching agent.

9. The etchant composition of claim 1, wherein the etchant composition further comprises one or more components selected from the group consisting of a surfactant, a metal ion blocking agent, a corrosion preventing agent, and a pH controlling agent.

10. A method of etching a substrate comprising
1) providing a substrate having a first metal film formed on a surface of the substrate, a second metal film formed on the first metal film, an optional additional metal film formed on the second metal film, and 2) contacting said substrate with an etchant composition of claim 1.

11. The method of claim 10 wherein the first metal film comprises molybdenum or titanium, and the second metal film comprises copper.

12. The method of claim 10 wherein the substrate is silicon, glass, stainless steel, plastic, or quartz.

13. The method of claim 10 wherein the first film and the second film are each formed on the substrate by vacuum deposition or sputtering, and wherein the contacting is conducted by dipping the substrate having the films on a surface of the substrate into the etchant solution, or by spraying the etchant solution onto the films on the substrate.

14. The method of claim 10 further comprising after step 1) and before step 2) layering a photoresist mask onto the second film, selectively exposing the mask, baking the substrate, and developing by contacting with a developing solution to form a photoresist pattern.

15. The method of claim 10 wherein in the etchant composition the high strength potassium monopersulfate is present at from about 2.5% to about 80% by weight of the composition.

16. The method of claim 10 wherein the high strength potassium monopersulfate is present at from about 0.03% to about 0.6% by weight of active oxygen.

17. The method of claim 10 wherein the etchant composition further comprises one or more components selected from the group consisting of a secondary oxidizer, an anisotropic etching agent, a surfactant, a metal ion blocking agent, a corrosion inhibitor, and a pH controlling agent.

18. The method of claim 17 wherein the secondary oxidizer is a ferric salt compound containing Fe3⁺ selected from the group consisting of Fe(NO₃)₃, Fe₂(SO₄)₃, NH₄Fe(SO₄)₂, FePO₄, and hydrates of each of the forgoing, or is a cupric salt selected from the group consisting of Cu(NO₃)₂, CuSO₄, NH₄CuPO₄, and hydrates of each of the forgoing.

19. The method of claim 17 wherein the anisotropic etching agent is an amine compound selected from the group consisting of pyrrolidine, pyrrolyn, pyrrole, indole, pyrazole, imidazole, pyrimidine, purine, pyridine, and aminotetrazole, tetraphenylphosphonium salts, substituted phosphonium salts, triphenylazolium salts, substituted tetrazolium salts, and substituted benzolium salts.

20. The method of claim 17 wherein the corrosion inhibitor is an organic acid, alkali metal salt thereof, or an anisotropic etching agent.
